(19) United States
(12) Patent Application Publication
(10) Pub. No.: US 2017/0374691 A1
(43) Pub. Date: Dec. 28, 2017

(54) SYSTEMS AND METHODS FOR MANAGING COMMUNICATION SESSIONS AT ENDPOINTS ACCESSIBLE VIA MORE THAN ONE NETWORK

(71) Applicant: VONAGE BUSINESS INC., Atlanta, GA (US)

(72) Inventors: Guy Bar On, Tel-Aviv (IL); Natan Shaltiel, Tel-Aviv (IL); May Ben Arie, Raanana (IL); Gil Osher, Marietta, GA (US); Sagi Iltus, Hadera (IL)

(21) Appl. No.: 15/190,979

(22) Filed: Jun. 23, 2016

(51) Int. Cl. H04W 76/02; H04M 7/12

(52) U.S. Cl. CPC H04W 76/02; H04M 7/1205; H04W 76/027

(57) ABSTRACT

Methods and systems for establishing communication sessions between communication endpoints. A method for operating a first communication endpoint having a processor, memory and a transceiver for establishing communication sessions with other communication endpoints includes communicating with a second communication endpoint in a first communication session between the first communication endpoint and the second communication endpoint over a first communication network. The communicating comprises executing a first communication application at the first communication endpoint. The method further includes receiving, at the first communication endpoint, an invitation to establish a second communication session with a third communication endpoint over a communication network, wherein the first mobile communication endpoint is provisioned to handle the second communication session by executing a second communication application at the first communication endpoint. The method further includes processing the received invitation according to a specified call treatment option without interruption of the first communication session.

### BACKGROUND

### Field

Embodiments of the present invention generally relate to methods and systems for managing communication sessions at endpoints which can be reached via more than one communication network.

### Description of the Related Art

Mobile communication endpoints such, for example, as smartphones, tablet computers, personal digital assistants (PDAs) and laptop or notebook computers, are typically able to access communication services via one or more communication networks via, for example, wireless and/or wired communication links. In many cases, the user of a mobile communication endpoint is able to establish voice communication sessions via either a data communication network, for example, such as the Internet, or via a mobile telephony service provider network (e.g., a cellular carrier network). To this end, a mobile communication endpoint may be configured to launch a non-native (or “over-the-top” or “OTT”) client application able to initiate outgoing and accept incoming invitations to establish a voice communication over a data communication network with another communication terminal. At the same time, the mobile communication endpoint may be configured to utilize a native call handling application of the mobile communication endpoint to initiate outgoing calls via a mobile telephony service provider network as well as to accept or reject income calls received over a mobile telephony service provider network.

The inventors have observed that when a voice communication session, established over a data communication network between a mobile communication endpoint and another communication endpoint using a non-native application, is active, the native call handling application of the mobile communication endpoint may receive invitations to set up voice communication sessions over the mobile telephony network. Such invitations can be distracting and disruptive to the communication session already active.

Accordingly, there exists a need in the art for more user-friendly and contextually aware methods and systems for minimizing interruptions of OTT communications on a mobile device by better handling invitations to establish a communication session over one network, when the mobile communication endpoint is already being used to conduct a communication session via a different network.

### SUMMARY

Methods and systems for managing, at a mobile communication endpoint, invitations to join communication sessions over one communication network—while a communication session is already active between the mobile communication endpoint and another endpoint via a different communication network—are described. In some embodiments, a method for operating a first mobile communication endpoint having a processor, memory and a transceiver for establishing communication sessions with other communication endpoints includes communicating with a second communication endpoint in a first communication session between the first mobile communication endpoint and the second communication endpoint over a first communication network, wherein the communicating comprises executing a first communication application at the first mobile communication endpoint. The method further includes receiving, at the first mobile communication endpoint, an invitation to establish a second communication session with a third communication endpoint over a second communication network that is different from the first communication network, wherein the first mobile communication endpoint is provisioned to handle the second communication session by executing a second communication application at the first mobile communication endpoint. The method further includes processing the received invitation according to a specified call treatment option without interruption of the first communication session.

In some embodiments, a mobile communication endpoint comprises at least one processor, a display, at least one transceiver operative to exchange signals, over a first communication network, based on execution of instructions of a first communication application by the at least one processor, with a second communication endpoint in a first communication session, and a memory containing instructions, executable by the processor, to receive, at the first mobile communication endpoint, an invitation to establish a second communication session with a third communication endpoint over a communication network, wherein the first mobile communication endpoint is provisioned to handle the second communication session by executing a second communication application at the first mobile communication endpoint, and to process the received invitation according to a specified call treatment option without interruption of the first communication session.

In some embodiments, a non-transitory computer readable medium contains instructions, executable by the processor of a mobile communication endpoint having a display and a transceiver, for establishing communication sessions with other communication endpoints by communicating with a second communication endpoint in a first communication session between the first mobile communication endpoint and the second communication endpoint over a first communication network, wherein the communicating comprises executing a first communication application at the first mobile communication endpoint; receiving, at the first mobile communication endpoint, an invitation to establish a second communication session with a third communication endpoint over a communication network, wherein the first mobile communication endpoint is provisioned to handle the second communication session by executing a second communication application at the first mobile communication endpoint; and processing the received invitation according to a specified call treatment option without interruption of the first communication session.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system for managing, at an enhanced communication endpoint, invitations to join communication sessions over one communication network while a communication session is already active between the enhanced communication endpoint and another endpoint via a different communication network, according to one or more embodiments;

FIG. 2 depicts a block diagram of an enhanced mobile communication endpoint, according to at least one embodiment consistent with the present disclosure;

FIG. 3 depicts a block diagram of an enhanced mobile communication endpoint, according to at least another embodiment consistent with the present disclosure;

FIG. 4 depicts a flow diagram of a method for specifying, at a mobile communication endpoint, treatment of an active first communication session, according to one or more embodiments consistent with the present disclosure;

FIG. 5 depicts a flow diagram of a method for configuring a mobile communication endpoint to process invitations to join/establish a communication session, according to one or more embodiments consistent with the present disclosure;

FIG. 6 depicts, as an exemplary sub-process of the method of FIG. 5, a flow diagram of a method for processing invitations to join a communication session, according to one or more embodiments consistent with the present disclosure;

FIG. 7 depicts, as an exemplary sub-process of the method of FIG. 5, a flow diagram of a method for processing invitations to join a communication session, according to other embodiments consistent with the present disclosure;

FIG. 8 is a call flow diagram depicting the establishing and processing of communication sessions, according to one or more embodiments consistent with the present disclosure;

FIGS. 9A through 9D depict the user interface of an enhanced mobile communication endpoint during operation in accordance with one or more embodiments consistent with of the present disclosure; and

FIG. 10 is an exemplary computer system configured to perform one or more methods consistent with the present disclosure.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present disclosure generally relate to methods and systems for minimizing interruptions of OTT communications on a mobile device by better handling an invitation to establish a communication session using one network while the mobile communication endpoint at which the invitation is received is already being used to conduct a communication session over a different network. More specifically, embodiments of the present disclosure apply a specified treatment at a mobile communication endpoint accessible via two or more distinct communication networks at the same time. The call treatment may be applied to a first communication session in progress between the mobile communication endpoint and a second communication endpoint via a first communication network. Alternatively, or in addition, the call treatment may be applied to an invitation to establish a second communication session between the mobile communication endpoint and a third communication endpoint via a second communication network.

In some embodiments, the specified treatment may comprise activation of a “do not disturb” mode of mobile endpoint operation. Thus, one or more incoming voice call(s) received at a mobile endpoint over, for example, a mobile communication network are blocked while the mobile endpoint is being actively used for an existing voice call over a data network (e.g, a voice over IP call over the Internet). In some embodiments, executions of instructions by a processor of the mobile communication endpoint may initiate display of a prompt to a user of the mobile endpoint to specify the applicable treatment as a default option. In some embodiments, execution of instructions may initiate display of a reminder to the user to deactivate the “do not disturb” option once the data network call has terminated. Where the native application (e.g., the instructions executable by a mobile communication endpoint to initiate, accept, and terminate calls over a mobile telephony service provider network) includes a suitable application programming interface (API), a toggling between the specified call treatment and a default call treatment of the native application may be performed automatically.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some exemplary embodiments described below are with respect to a mobile Voice over Internet Protocol (VOIP) telecommunication app. However, one skilled in the art will readily recognize from the following description that other types of applications may be used in embodiments consistent with the present invention without departing from the principles of the disclosure described herein.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

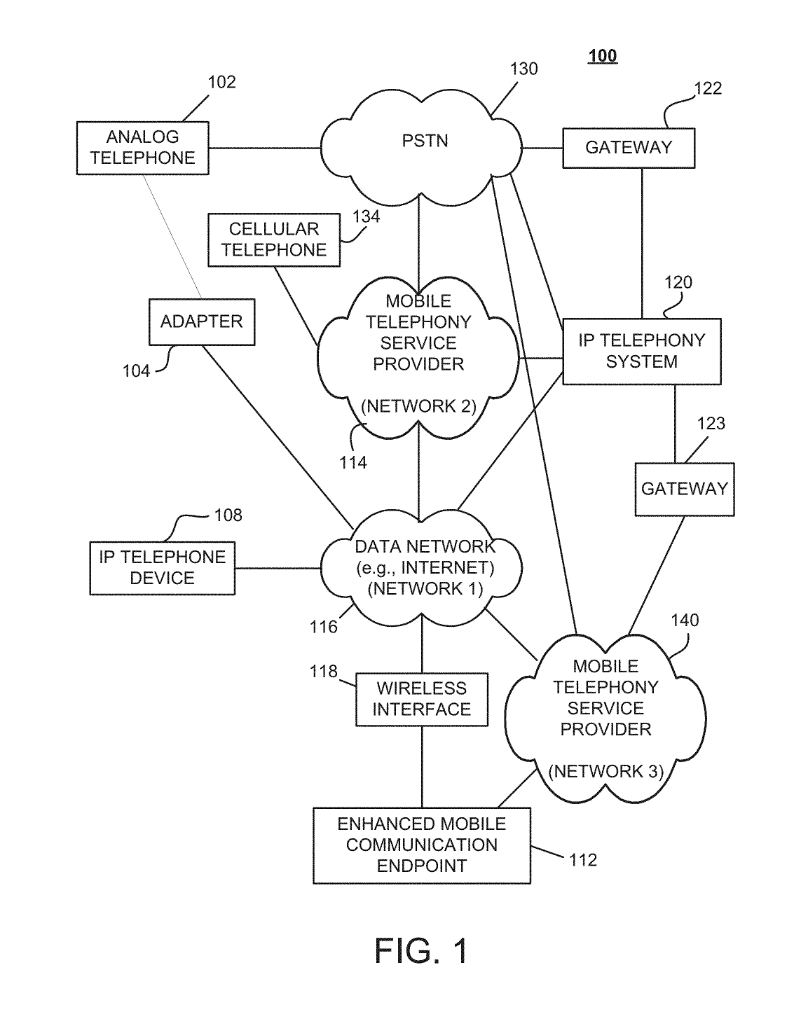

As illustrated in FIG. 1, a communications environment 100 is provided to facilitate IP enhanced communications. An IP telephony system 120 enables connection of telephone calls between its own customers and other parties via data communications that pass over a data network 116. The data network 116 is commonly the Internet, although the IP telephony system 120 may also make use of private data networks. The IP telephony system 120 is connected to the Internet 116. In addition, the IP telephony system 120 is connected to a publicly switched telephone network (PSTN) 130 via a gateway 122. The PSTN 130 may also be directly coupled to the Internet 116 through one of its own internal gateways (not shown). Thus, communications may pass back and forth between the IP telephony system 120 and the PSTN 130 through the Internet 116 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone device 108 that is connected to the Internet 116. Such an IP telephone device 108 could be connected to an Internet service provider via a wired connection or via a wireless router. In some instances, the IP telephone device 108 could utilize a packet-switched network of a cellular telephone system to access the Internet 116.

Alternatively, a customer could utilize an analog telephone 102 which is connected to the Internet 116 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

Users of the IP telephony system 120 are able to access the service from virtually any location where they can connect to the Internet 116. Thus, a customer could register with an IP telephony system provider in the U.S., and that customer could then use an IP telephone device 108 located in a country outside the U.S. to access the services. Likewise, the customer could also utilize a computer outside the U.S. that is running a soft-phone client to access the IP telephony system 120.

A third party using an analog telephone (not shown) which is connected to the PSTN 130 may call a customer of the IP telephony system 120. In this instance, the call is initially connected from the analog telephone to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “enhanced communication endpoint.” This term is used to refer to any type of communication terminal or system which is capable of interacting with two or more distinct communication networks. By way of illustration, an enhanced communication endpoint may exchange packets, over a data communication network such as the Internet, with an IP telephony system to complete an audio or video telephone call or to send and receive text messages. In addition, an enhanced communication endpoint may be capable of interacting with another communication endpoint via an exchange of packets over a peer-to-peer network connection.

An enhanced mobile communication endpoint is particular form of enhanced communication endpoint in that it is further able to interact with a network operated by a mobile telephony service provider (e.g., a cellular carrier network). Examples of enhanced mobile communication endpoints include smartphones, tablet computers, and personal digital assistants (PDAs) configured with one or more transceiver(s), a processor, and memory to execute both an IP telephony client application and an application for connectivity to a mobile telephony service provider network or some other communication network operated independently of the data communication network. Since the application executed by the enhanced mobile communication endpoint to implement mobile telephone connectivity is typically developed to run on an endpoint, or to provide compatibility with a particular network platform, that application may be referred to herein as a “native” application. It suffices to say that an enhanced mobile communication endpoint is one which is capable of operating as both a cellular telephone, to facilitate voice calls as voice-network based communication sessions, and an IP telephone that can facilitate voice calls as data based communication sessions.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device. In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that an enhanced mobile communication endpoint 112 with cellular and data network access capabilities (e.g., a smartphone) is capable of establishing a wireless data connection with a first wireless interface 118 (e.g. a wireless access point) such, for example, as an IEEE 802.11 compliant router. The wireless interface 118 is coupled to the Internet 116 (i.e., Network 1). Thus, for example, the enhanced mobile communication endpoint 112 can establish a communication session such as a VOIP telephone call, using IP telephony system 120, via a path through the Internet 116, wireless interface 118, and Network 1.

FIG. 1 also illustrates that the enhanced mobile communication endpoint 112 may establish a second wireless data connection via a packet-switched network provided by a cellular service provider network (using its cellular telephone capabilities), or it may establish a voice based session telephone call via a circuit-switched network operated by a mobile telephony service provider network 140 (“Network 3”) and/or by a mobile telephony service provider network 114 (“Network 2”). Although multiple access networks (e.g. data networks and voice networks may be used to carry out various embodiments consistent with the present disclosure, it should be borne in mind that in many embodiments, a single communication network may be accessed by the communication endpoint 112 to establish communication sessions according to multiple, different communication applications executable on the same communication endpoint 112.

Although not illustrated in FIG. 1, enhanced mobile communication endpoint 112 may be capable of establishing a wireless data connection to a data network, such as the Internet 116, via alternate means. For example, the enhanced mobile communication endpoint 112 might link to some other type of wireless interface using an alternate communication protocol, such as the wireless local area network (WLAN) based on the Institute of Electrical and Electronics Engineers' (IEEE) 802.11, 802.13 and 802.16 standards. In addition, enhanced mobile communication endpoint 112 may be capable of established a peer-to-peer (P2P) connection directly with another enhanced mobile communication endpoint (not shown). In some embodiments, enhanced mobile communication endpoint 112 may be connected to internet 116 via a WLAN connection, and the like, and can also establish a VOIP telephone calls with the IP telephony system 120 via gateway 123.

In the embodiments consistent with the present disclosure, a device may act as an enhanced mobile communication endpoint once it is configured with appropriate application software that may be downloaded from an app distribution platform (not shown). For example, enhanced mobile communication endpoint 112 may download a VOIP mobile app from an app distribution platform (not shown) and install the VOIP mobile app locally making the app execute alongside a native application also executing on enhanced mobile communication endpoint 112. The VOIP mobile app facilitates voice calls over a first communication network (e.g., Internet 116) while the native application facilitates voice calls over a second communication network (e.g., mobile telephony service provider network 140) and/or a third communication network (e.g, mobile telephony service provider network 114).

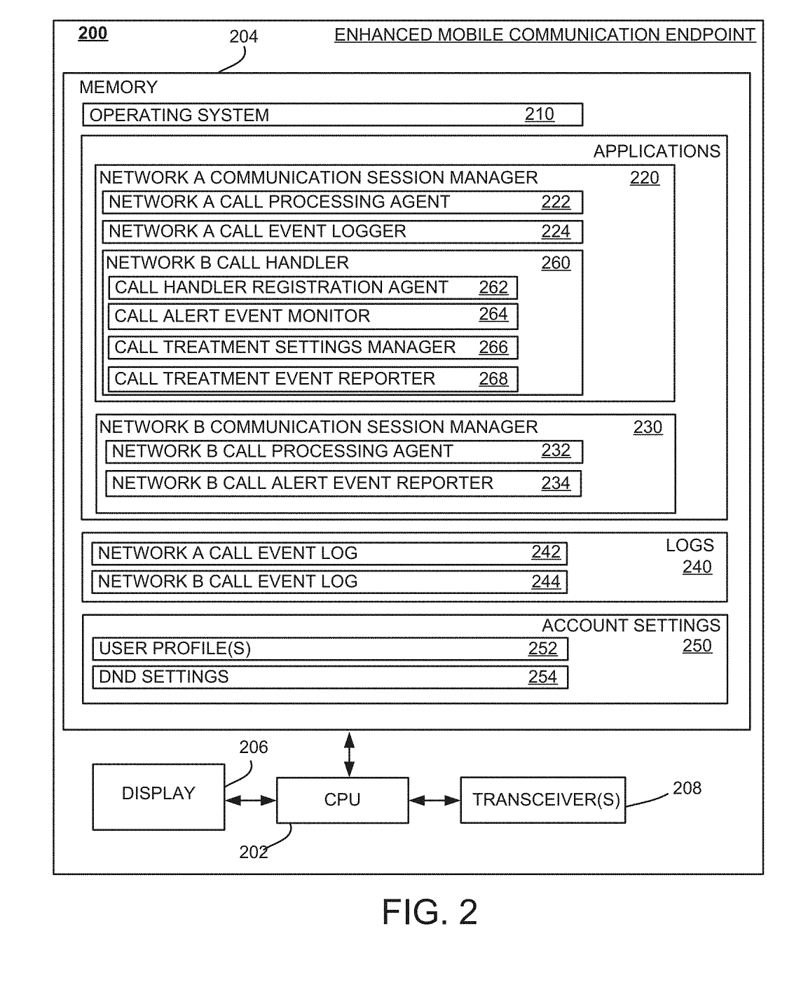

FIG. 2 depicts a block diagram of a communication endpoint 200 having access to two or more networks such that invitations to join communication sessions may be received over one communication network while a communication session is already active between the enhanced communication endpoint and another endpoint via a different communication network. In some embodiments, as shown in FIG. 2, the endpoint 200 is an enhanced mobile communication endpoint having at least one processor, as central processing unit (CPU) 202, a memory 204 operatively coupled to the CPU 202, a display 206, and transceiver(s) 208 for establishing corresponding communication links with a first network (“Network A”) such as the data network 116 of FIG. 1, and a second network (“Network B”), such as mobile telephony service provider network 140, respectively.

The CPU 202 may comprise one or more commercially available microprocessors or microcontrollers that facilitate data processing and storage. Various support circuits (not shown) facilitate the operation of the CPU 202 and include one or more clock circuits, power supplies, cache, input/output circuits, and the like. The memory 204 comprises at least one of Read Only Memory (ROM), Random Access Memory (RAM), disk drive storage, optical storage, removable storage and/or the like. In some embodiments, the memory 204 comprises an operating system 210, a Network A communication session manager 220 for establishing and managing communication sessions supported by a data network, and a Network B communication session manager 230 for establishing and managing communication sessions (e.g, cell phone calls) supported by a mobile telephony service provider network. In embodiments, the Network B communication session manager 230 forms part of a native application configured to initiate, establish, maintain and terminate connectivity between endpoint 200 and a mobile telephony service provider network.

The operating system (OS) 210 generally manages various resources of the enhanced communication endpoint (e.g., network resources, file processors, and/or the like). The operating system 210 is configured to execute operations on one or more hardware and/or software modules, media, virtualization layers, and/or the like. Examples of the operating system 210 may include, but are not limited to, LINUX, MAC OSX, BSD, UNIX, MICROSOFT WINDOWS, IOS, ANDROID and the like.

In embodiments, the Network A communication session manager 220 includes a call processing agent 222, a call event logger 224, and a Network B call handler 260 which includes a call handler registration agent 262, a call alert event monitor 264, a call treatment settings manager 266, and a call treatment event reporter 268. When an invitation to establish a communication such as a voice call is received at Network A, it is received by call processing agent 222 which, in turn, initiates display of an alert to the user of endpoint 200 via display 206. In one or more embodiments, Network A is a data network over which voice calls may be established by an exchange of packets in accordance, for example, with the Session Initiation Protocol (“SIP”) protocol. According to this protocol, a “calling in” invitation message is received via Network A. If the invitation is not rejected, the call processing agent enters an “active” state and the endpoint 200 responds by sending an acknowledgment (e.g, a “200 OK”) message confirming the transition and acceptance of the call.

According to aspects of the SIP protocol, the call processing agent 222 transitions back to an “idle” state when an active voice call terminates, transitions from the “active” state to or from an “on hold” state in response to user input (or, if the on hold status was not initiated by the user of endpoint 200, in response to an “invite” message received by another endpoint), transitions from the “idle” state to a “calling out” state when user input corresponding to an instruction to place a call from endpoint 200 over Network B is received, transitions from the “calling in” state back to the “idle” state when an incoming call is rejected by endpoint 200, and transitions from the “calling out” state back to the “idle” state when an outgoing call is rejected by the remote endpoint.

Also stored within memory 204 are event logs 240, and account settings 250. Event log 240 may include a Network A log 242 for storing events associated with connectivity to Network A. These events may include the initiation and termination of a communication session established at endpoint 200 via Network A, as well as the rejection of an invitation to establish such a communication session. Event logs 240 may also include a Network B log 244 for storing events associated with connectivity to Network B such as the initiation and termination of a communication session established at endpoint 200 via Network B, as well as the rejection of an invitation received to establish such a communication session with endpoint 200. The account settings 250 may include user profiles 252 and, in accordance with embodiments consistent with the present invention, Do Not Disturb (“DND”) settings or other call treatment options set by default and/or as one of several options selectable by a user of endpoint 200. In embodiments, Network A event logger 224 initiates entry, in the Network A call event log 242, of such events as call acceptance, call rejection, and call termination by call processing agent 222.

Network B communication session manager 230 includes a Network B call processing agent 232 and a Network B Call Alert Event Reporter 234. In embodiments, Network B call processing agent 232 performs all of the functions of a native mobile telephony call processing application when the Network A Call Processing agent 222 of Network A Communication Session Manager 220 is not in an active state, and a subset of these functions when the Call Processing agent 222 is in an active or an on-hold state. Such functions typically include receipt and acknowledgement of radio frequency (RF) alert signals received from a mobile telephony service provider network from, for example, the nearest base station, and operation of the transceiver to initiate, maintain and terminate the RF link in support of a call over Network B.

In one or more embodiments, the default or user-elected treatment of an invitation to establish a communication session over Network B is not to place an active Network A communication session on hold in favor of establishing a new call over Network B. Indeed, in some embodiments, a default treatment of the Network B communication session invitation may be to allow Network B to redirect the invitation, in accordance with account settings enforced by a server of Network B, to a voice mail server or to an alternative endpoint associated with a designated “back up” call recipient. Thus, for at least some default or user-selected call treatment settings, call processing agent 232 does not immediately initiate display of a visual and/or audible alert to the user of endpoint 200 when an incoming invitation to establish a communication session via Network B is received.

In one or more embodiments, Network A call event logger 224 sends a call event notification to the Network A call handler 260 when the Network A call processing agent 222 is in the active state. This call event notification is detected by the call handler event monitor 264 of call handler 260 which, in turn, causes call handler registration agent 262 to activate a “block native call” setting of call treatment settings manager 266. Likewise, when Network A call processing agent 222 is no longer in the active state, call event logger 224 sends a new call event notification to the Network A call handler event monitor 264 which, in turn, causes the call handler registration agent 262 to activate a “do not block native call” setting of call treatment settings manager 266. In embodiments, a Do Not Disturb (DND) “on” setting of Network B DND settings 254 applies when the “block native calls” setting of the call treatment settings manager 266 is active, and a DND “off” setting of Network B DND settings 254 applies when the “do not block native calls” setting is active.

When an incoming “native call” invitation arrives at endpoint 200 via Network B while the DND setting applies, the incoming invitation may either be ignored or it may be actively blocked in the same manner as if the user of the endpoint had actively requested rejection of the call in response to a visual, audible, and/or haptic alert(s). Because the aforementioned process obviates the need for such alert(s), the user of endpoint 200 is spared any distraction or disruption during a pre-existing communication session. Likewise, when the DND settings reflects a “do not block” setting, the Network B call processing agent 22 proceeds to establish a call over Network B in a conventional manner. In some embodiments, call treatment event reporter 268 provides the user of endpoint 200 with a missed call notification (e.g., by initiating display, to the display 206, of a message about the blocked or ignored call invitation). The missed call notification may be presented to the user of endpoint 200 during or after the conclusion of the Network A communication session. In some embodiments, the missed call notification may be in the form of a “whisper message” audibly reproduced via the earpiece speaker (not shown) of endpoint 200 during the Network A communication session.

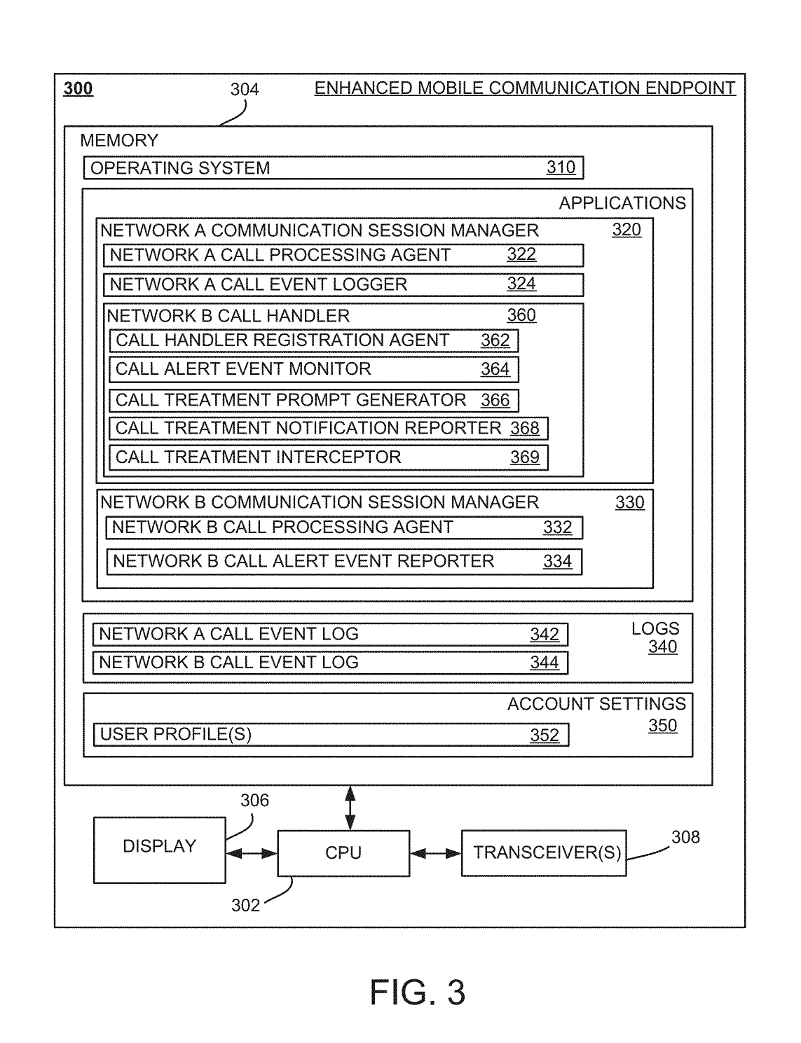

FIG. 3 depicts a block diagram of an enhanced mobile communication endpoint 300 configured to manage invitations to join communication sessions over one communication network while a communication session is already active between the enhanced communication endpoint and another endpoint via a different communication network. Embodiments of the disclosure consistent with FIG. 3 are similar to those consistent with FIG. 2. However, in the embodiment of FIG. 3, the Network B call handler 360 of Network A communication session manager 320 includes instructions, executable by CPU 302 while a Network A communication session is in progress, to initiate display of an alert to the user of endpoint 300 when an incoming Network B invitation arrives and to give the user an opportunity to control how one or both of the communication and invitation are managed at the endpoint 300.

The endpoint 300 is an enhanced mobile communication endpoint having at least one processor, as central processing unit (CPU) 302, a memory 304 operatively coupled to the CPU 302, a display 306, and transceiver(s) 308 for establishing corresponding communication links with the first network (i.e., Network A) which may be a data network and with the second network (i.e., Network B), which may be a mobile telephony service provider network.

In some embodiments, the memory 304 comprises an operating system 310, a Network A communication session manager 320 for establishing and managing communication sessions supported by a data network, and a Network B communication session manager 330 for establishing and managing communication sessions (e.g, cell phone calls) supported by a mobile telephony service provider network. In embodiments, the Network B communication session manager 330 forms part of a native application configured to initiate, establish, maintain and terminate connectivity between endpoint 300 and a mobile telephony service provider network.

In embodiments, the Network A communication session manager 320 includes a Network A call processing agent 322, a Network A call event logger 324, and a Network B call handler 360. Network B call handler 360 includes a call handler registration agent 362, a call alert event monitor 364, a call treatment prompt generator 366, a call treatment notification reporter 368, and a call treatment interceptor 369. When an invitation to establish a communication such as a voice call is received at endpoint 300 via Network A, it is received by call processing agent 322 which, in turn, initiates display of an alert to the user of endpoint 300 via display 306. In one or more embodiments, Network A is a data network over which voice calls may be established by an exchange of packets in accordance, for example, with the Session Initiation Protocol (“SIP”) protocol. The call processing agent 322 transitions between idle, active, calling-in, calling-out, and on-hold states in the same manner as previously described for call processing agent 222.

Also stored within memory 304 are event logs 340, and account settings 350 such as user profiles 352. Event logs 340 may include a Network A log 342 for storing events associated with connectivity to Network A as previously described, as well as a Network B log 344 for storing events associated with connectivity to Network B, also as previously described.

Network B communication session manager 330 includes a Network B call processing agent 332 and a Network B Call Alert Event Reporter 334. In embodiments, Network B call processing agent 332 performs all of the functions of a native mobile telephony call processing application when the Network A Call Processing agent 322 of Network A Communication Session Manager 320 is not in an active state or, optionally, is in an on hold state. Such functions typically include receipt and acknowledgement of radio frequency (RF) alert signals received from a mobile telephony service provider network from, for example, the nearest base station, and operation of the transceiver to initiate, maintain and terminate the RF link in support of a call over Network B.

In one or more embodiments, the user is presented with an opportunity to specify the call treatment to be given to an invitation to establish a communication session over Network B at endpoint 300 when an existing communication session is in progress over Network A. In some embodiments, the user-specified treatment of the Network B communication session invitation may be to accept it, to reject it, or to direct it. In an embodiment, if the Network B invitation is rejected, Network B call handler 360 “intercepts” the incoming invitation by accepting a transfer of control over it from the Network B call processing agent 332 of Network B communication session manager 330.

In one or more embodiments, call handler registration agent 362 registers the Network A communication session manager 320 as a native “call handler” to process call event alert events generated by the Network B call alert event reporter 334 of Network B communication session manager 330. When an incoming invitation for endpoint 300 to accept a call over Network B arrives, the invitation event is reported to the call alert event monitor 364 by network B call event reporter 334. If Network A call processing agent 322 is in a Network A call inactive state, call handler registration agent 362 reports to call processing agent 332 that Network A call processing agent 322 does not seek control over the incoming Network B invitation. As such, the Network B call processing agent 332 retains control and processes the call invitation as a native call supported by Network B.

If, however, Network A call processing agent 322 is in a Network A call active state, call treatment prompt generator 366 initiates visual and/or audible presentation of a prompt requesting input of a user call treatment selection. The prompt may, for example, request that the user elect whether to accept or reject the Network B invitation. User input is captured and reported by call treatment notification reporter 368. If the user has elected to reject the Network B invitation, call treatment interceptor 369 reports to Network B call processing agent 332 that the Network B call handler 360 of the Network A communication session manager 320 will take control over the incoming Network B invitation. As such, the Network B call processing agent 332 surrenders control over the call invitation to the Network B call handler 360.

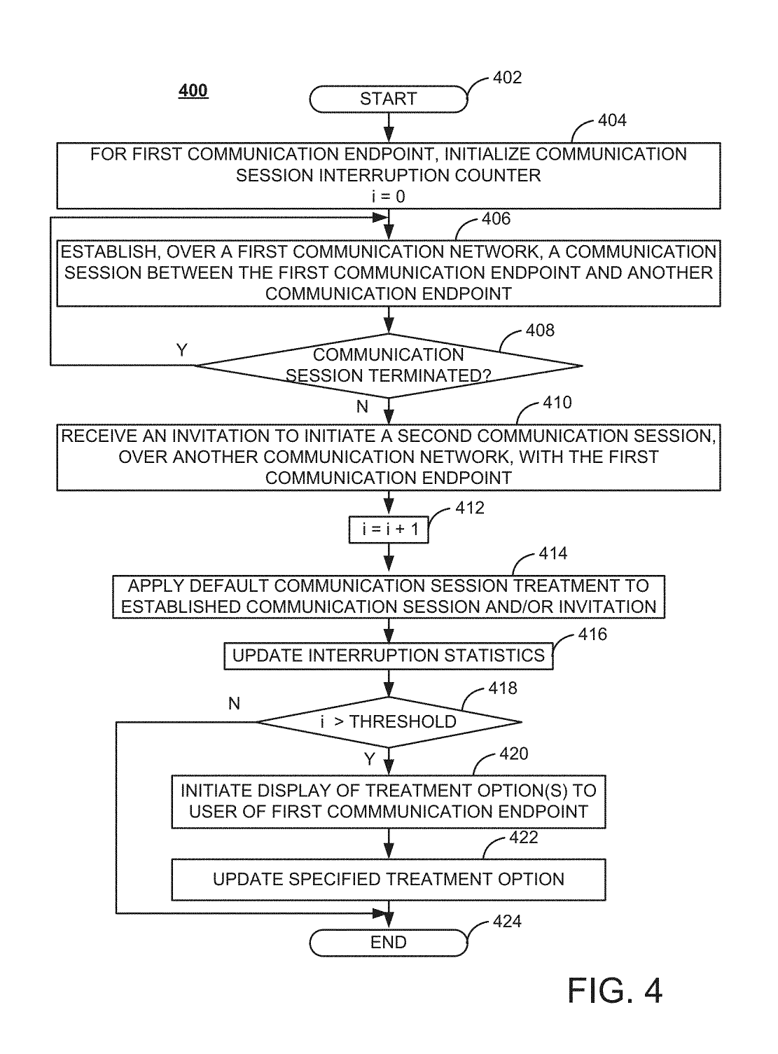

FIG. 4 depicts a flow diagram of a method 400 for specifying, at a mobile communication endpoint, treatment of an active first communication session using a first communication network and/or an invitation to join a second communication session using a second communication network while the first communication session is still active, as a sub-process of according to one or more embodiments consistent with the present disclosure. The method 400 is entered at 402 and proceeds to 404 where, for a first communication endpoint, a communication session interruption counter i is initialized by setting its value to zero. The method 400 proceeds to 406.

At 406, a communication session is established, over a first communication network, between an enhanced communication endpoint and another communication endpoint. One or both of the communication endpoints may be enhanced mobile communication endpoints. However, in some embodiments, the other endpoint may comprise a conferencing server, a voice messaging server, or even an email server configured as part of a unified communication system to provide voice services to an enhanced communication endpoint over a data network. As such, the first network may be a data network suited to the exchange of packets between communication endpoints.

From 406, method 400 proceeds to 408 where a determination is made as to whether the communication session served by the first network has terminated. If so, the process returns to 406 without incrementing the value of the counter. If, however, the communication has not terminated, the method 400 proceeds to 410 where an invitation is received to initiate a second communication session with an enhanced communication endpoint over a communication network other than the first communication network. In an embodiment, the other communication network is a mobile telephony service provider (i.e., cellular carrier) network. From 410, the method 400 proceeds to 412, where the counter value i increments by one. The method 400 then proceeds to 414.

At 414, a default communication session treatment is applied to the communication session already established over the first network and/or to the invitation received to establish a communication session over the second network. The default treatment may include, for example, rejection of the invitation. From 414, method 400 advances to 416, wherein statistics including, for example, the number of interruptions received over one or a plurality of different time intervals (by hour, day of week, weekly, or the like) are updated to reflect receipt of the latest invitation received. From 416, method 400 advances to 418.

At 418, method 400 determines whether the value of the counter i has exceeded a threshold as defined for one or more of the windows for which statistics are updated at 416. If not, the method 40 terminates at 424. If so, however, the method proceeds to 420 and initiates display of treatment options to the user of the first enhanced communication endpoint. The user may, for example wish to change from one default option, by which the communication session over the first network is placed on hold and the incoming invitation accepted by establishing a call over the second network, to another default option, by which the communication session over the first network continues and the incoming invitation is rejected or allowed to go to voice mail by non-intervention (i.e., inaction by a native communication application executing on the enhanced communication endpoint). From 424 the method 400 proceeds to 424 and terminates or, in other embodiments, it may return to 406 and continue gathering statistics until the communication session terminates.

The process depicted in FIG. 4 admits of substantial variation. By way of alternative example, the system may access a profile associated with a user of the endpoint receiving an incoming invitation and/or gather such user-centric contextual information as an identity of one or more other participants in an existing call, the time of day, the location of the communication endpoint, and/or the identity (e.g., caller ID) of the communication invitation originator. Based on analysis of the profile and/or context, and one of several defaults may be implemented automatically or the user may be prompted with a displayed option to apply one or several defaults selected based on the aforementioned.

Alternatively, or in addition, based on a user's response to take or reject an incoming communication session invitation during an existing application, the user may be requested with a series of prompts to construct a profile. For example, a user may be prompted upon the conclusion of all active communication sessions, (or may be sent an inquiry via SMS or email to provide the response), to confirm whether the action taken should be applied (a) anytime a communication session invitation is received from the same caller without regard to whether an existing call is in progress; (b) anytime a communication session invitation is received from the same caller only when an existing call is progress; or (c) anytime a communication session is received from the same caller only when an existing call with the same participant(s) is in progress. In some embodiments, any or all of the above prompts might be followed with additional prompts such, for example, as to add or confirm a particular range of times and/or days of the week for the applicable action to be applied.

It suffices to say that a wide variety of call treatment behavior may be triggered and/or suggested to the user, for current or prospective application, without departing from the spirit and scope of the present disclosure.

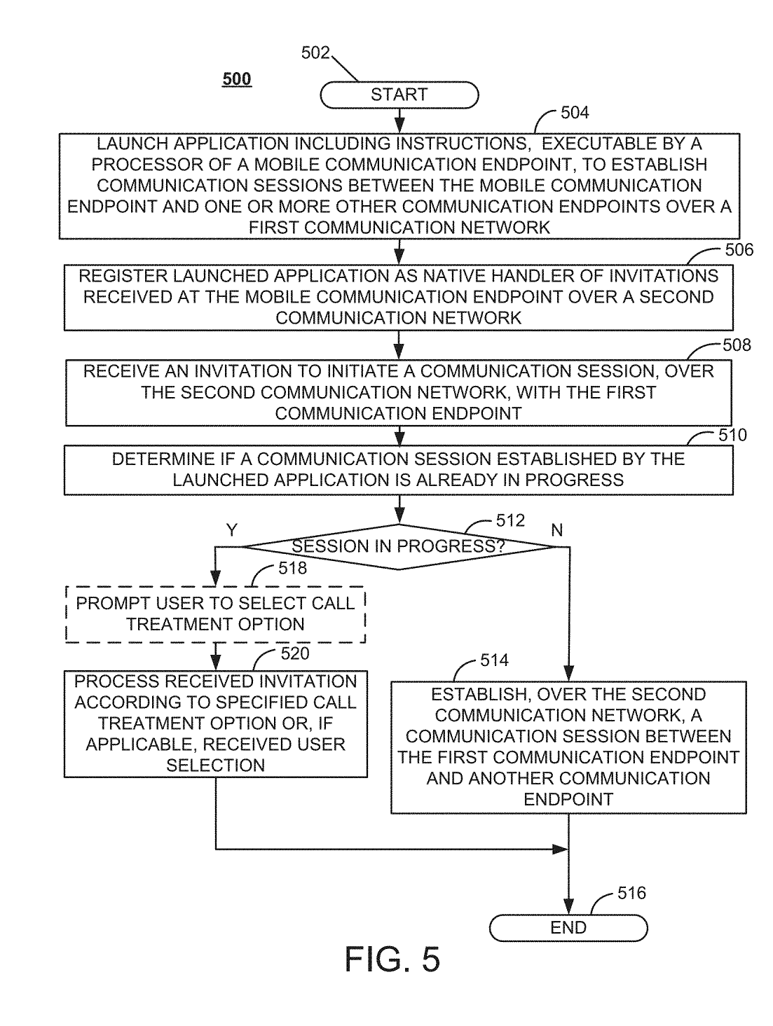

FIG. 5 depicts a flow diagram of a method 500 for configuring a mobile communication endpoint to process invitations to join/establish a communication session using one communication network while an active communication session using a different communication network is in progress, according to one or more embodiments consistent with the present disclosure,

The method 500 is entered at 502 and proceeds to 504, where an application that includes instructions, executable by a processor of an enhanced mobile communication endpoint to establish communication sessions with one or more other communication endpoints over a first communication network, is launched. From 504, method 500 proceeds to 506, where the launched application is registered as a native handler of invitations, received at the enhanced mobile communication endpoint, to establish voice calls at the enhanced communication endpoint. From 506, the method proceeds to 508, where an invitation is received to establish, with the enhanced communication endpoint, a communication session using the second communication network.

From 508, method 500 proceeds to 510, where a determination is made as to whether a communication session (e.g. a voice call or voice mail retrieval session) is already in progress at the enhanced communication endpoint receiving the invitation. At 512, the method 500 proceeds to 514 if the determination is negative and to at least 520, optionally after 518, if the determination is positive.

At 514, a communication session is established over the second communication network between the enhanced mobile communication endpoint and the communication endpoint from which an invitation was received at 508. From 514, method 500 advances to 516 and terminates.

At optional block 518, the user may be prompted to select a call treatment option. In some embodiments, this selection has prospective effect and applies to as a default action all future calls, while in other embodiments, the user may be offered the opportunity to select a call treatment each time an affirmative response is returned at 512 from the determination at 510. From 518, or 512 as the case may be, method 500 proceeds to 520, where the invitation received at 508 is processed according to a user-specified and/or default selection (e.g. by rejecting the invitation) and continuing to manage an active call state for the session supported by the first network. From 520, method 500 advances to 516 and terminates.

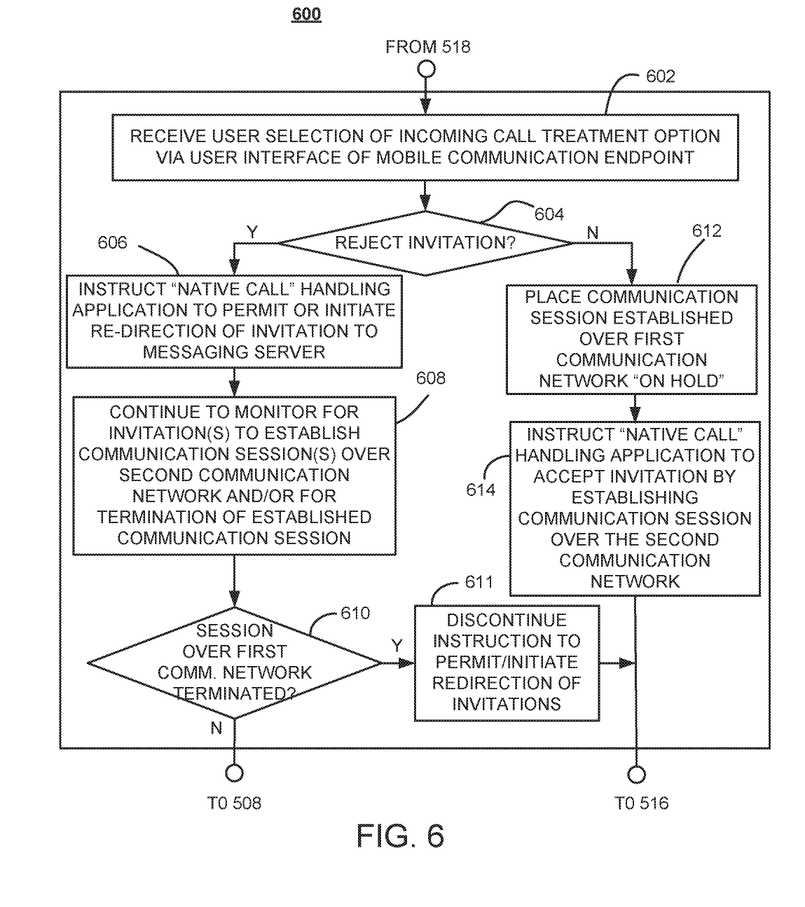

FIG. 6 depicts, as an exemplary sub-process of the method 500 of FIG. 5, a flow diagram of a method 600 for processing invitations to join a communication session using one communication network while an active communication session using a different communication network is in progress, according to one or more embodiments consistent with the present disclosure. The method 600 proceeds as from 518 of method 500 and is entered at 602, where a user selected option for incoming call treatment is received via the user interface (e.g. touch pad or key pad entry) of an enhanced mobile communication endpoint. The method 600 proceeds to 604, where a determination is made as to whether the selected option is to reject the invitation, in which case method 600 advances to 606, or to accept the invitation, in which case method 600 advances to 612.

At 606, a native call application being executed by a processor of the enhanced mobile communication endpoint is instructed to permit or initiate redirection of the invitation received during, for example, execution at 508 of method 500, to a messaging server or other destination. From 606, method 600 proceeds to 608 where method 600 continues to monitor for invitation(s) to establish communication session(s) over the second communication network and/or for termination of the communication session established over the first communication network. The method 600 proceeds from 608 to 610 where a determination is made as to whether the session over the first communication network has terminated. If not, method 600 returns to 508 of method 500. If so, method 600 proceeds to 611 and discontinues the instruction to permit/initiate redirection of invitations supported by the second communication network. From 611, method 600 returns to 516 of method 500.

At 612, a communication session placed over the first communication network is placed “on hold” and, at 614, the native call handling application executing on the enhanced mobile communication endpoint is instructed to accept the incoming invitation by establishing a communication session over the second communication network. From 614, method 600 returns to 516 of method 500.

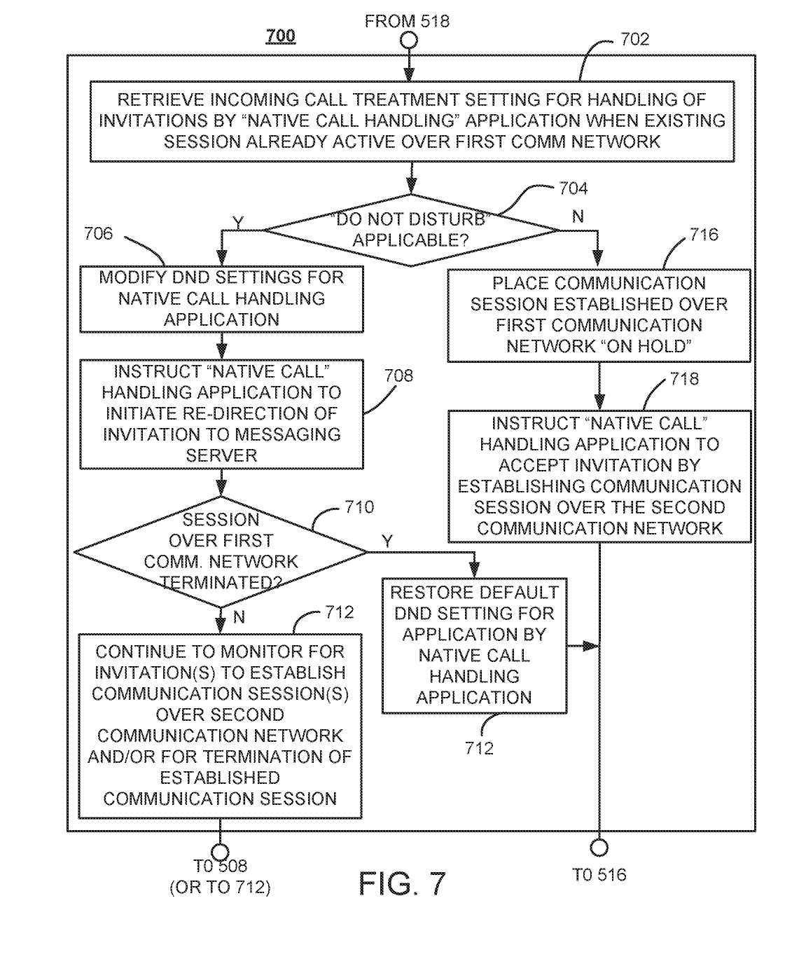

FIG. 7 depicts, as an exemplary sub-process of the method 500 of FIG. 5, a flow diagram of a method 700 for processing invitations to join a communication session using one communication network while an active communication session using a different communication network is in progress, according to other embodiments consistent with the present disclosure. The method 700 proceeds from 518 of method 500 and is entered at 702, where an incoming call treatment setting—for handling of invitations by a native call handling application when an existing communication session is already active over the first communication network—is retrieved from memory by execution of instructions by a processor of an enhanced mobile communication endpoint.

The method 700 proceeds to 704, where a determination is made as to whether the retrieved setting specifies that a do not disturb treatment applies. If so, method 700 proceeds to 706 and modifies the DND settings used by the native call handling application 706 so that they specify the do not disturb treatment. From 706, method 700 proceeds to 708, where the native call application initiates or permits, by inaction, re-direction of the invitation to a message server in accordance with the do not disturb treatment. The method 700 then proceeds to 710, where a determination is made as to whether the session over the first communication network has been terminated. If not, the method proceeds to 712, where method 700 continues to monitor for invitation(s) to establish communication session(s) over the second communication network and/or for termination of the communication session established over the first communication network. From 712, method 700 persists until a monitored event occurs, at which point method 500 resumes at 508 or proceeds to 712. If the determination at 710 is that the session has been terminated, the method also proceeds to 712, where default DND settings are restored for application by the native call application. Thereafter, method 500 resumes at 516.

If at 704, it is determined that the do not disturb treatment is not applicable, the method 700 proceeds to 716, where the communication session established over the first communication network is placed “on hold” and to 718, where the native call handling application is instructed to accept a received invitation by establishing a communication session over the second communication network. From 718, method 500 is resumed at 516.

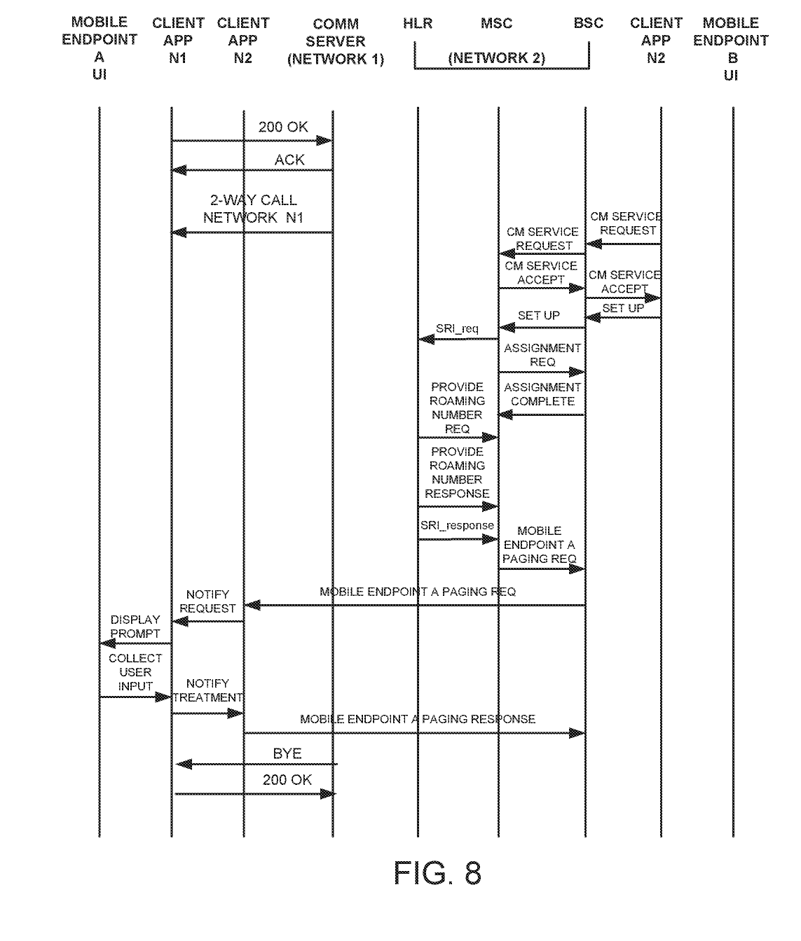

FIG. 8 is a call flow diagram depicting the establishing and processing of communication sessions, at an enhanced mobile endpoint having access to mobile communication services provided by two different networks, according to one or more embodiments consistent with the present disclosure. As seen in FIG. 8, enhanced mobile communication endpoint A executes a client app N1 which causes that endpoint to accept a SIP invitation in order to establish a communication session over the data network (Network 1) with which a communication server is associated. Such acceptance is signified by a “200 OK” message send to, and acknowledged by, the server.

Subsequently, a communication message (CM) service request is sent by a native communication application (client app N2) executing on a mobile terminal (Mobile Endpoint B) which may or may not lack support for a client application such as the client application N1 to accommodate a data network protocol such as SIP. Through an exchange of signaling between Mobile Endpoint B and Network 2, which may, for example, comprise a GSM network that includes a home location register (HLR), a mobile switching center (MSC) and a base station controller (BSC). The home location register (HLR) is a central database that contains details of each mobile phone subscriber that is authorized to use the GSM core network. There can be several logical, and physical, HLRs per public land mobile network, though one international mobile subscriber identity (IMSI)/MSISDN pair can be associated with only one logical HLR (which can span several physical nodes) at a time. The HLRs store details of every SIM card issued by the mobile phone operator. Each SIM has a unique identifier called an IMSI which is the primary key to each HLR record.

The mobile switching center (MSC) is the primary service delivery node for GSM/CDMA, responsible for routing voice calls and SMS messages as well as other services (such as conference calls, FAX and circuit switched data). The MSC sets up and releases the end-to-end connection, handles mobility and hand-over requirements during the call and takes care of charging and real time pre-paid account monitoring.

Finally, the BSC handles allocation of radio channels, receives measurements from the mobile phones, and controls handovers from base station transceiver stations (not shown). The base station transceiver stations contains the equipment for transmitting and receiving radio signals (transceivers), antennas, and equipment for encrypting and decrypting communications with the base station controller. In an embodiment, the BSC sends a mobile endpoint paging request to endpoint A, which by the endpoint and processed initially by a second communication client application (“N2”) stored in a memory of and executed by a processor of endpoint A. The second communication client application N2 sends a notify request to a first communication client application (“N1”). Client application N1 initiates display of a prompt to the display (and/or audible reproduction by a speaker) of endpoint A. User input corresponding to a treatment confirmation/request is entered by, for example, touchscreen, “soft” feature button depression, or audible speech input. The user input thus entered is processed by client application N1 which, in turn, generates a treatment notification for processing by client application N2. In embodiments, the mobile endpoint paging response is generated by client application N2 and sent to the BSC. In one embodiment, the “notify treatment” signals to the BSC that the call invitation is to be dropped and rejected by endpoint A.

The pre-existing communication session, mediated by the communication server, continues until one of the parties terminates. In FIG. 7A, the call is terminated by another remote communication endpoint (not shown), which results in the communication server sending a “BYE” message to endpoiont A. The first communication client application N1 sends a 200 OK message to acknowledge that it has received and processed the “end session” message.

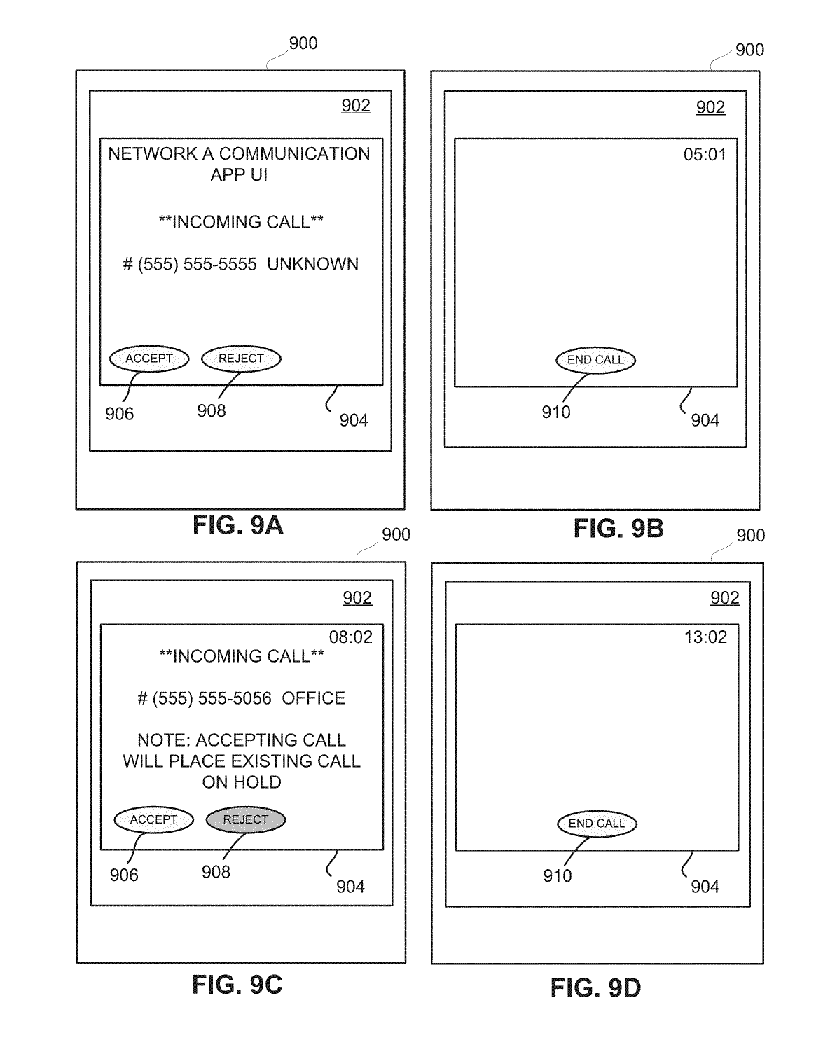

FIGS. 9A through 9D depict the user interface of an enhanced mobile communication endpoint during operation in accordance with one or more embodiments consistent with of the present disclosure. FIG. 9A depicts an enhanced mobile communication terminal executing a communication client application such as an IP telephony application. The user interface is presented on display 902 which contains a user interface window 904 showing an alert message generated by execution of the IP communication client in response to receipt of an invitation to establish a communication session over a data communication network able to support IP telephony applications. In the illustrated case, the call received is from a caller having the caller ID (555) 555-5555 and the user interface window contains two “soft” buttons, 906 and 908 giving the user of endpoint 900 to accept or reject the call, respectively.

FIG. 9B depicts the progression of the user interface display window 904 to a “call in progress” mode, after the user of endpoint 900 has accepted the incoming call depicted in FIG. 9 and during which an elapsed time is displayed in the upper right corner and an “end call” soft button 910 is displayed. Continuing to FIG. 9C, the user interface display window, at time interval 8:02 during the same call, depicts an example presentation of a prompt to the user of endpoint 900 when a call invitation arrives to establish a call using a different network as, for example, a mobile service provider voice network. At interval 8:02, the user is advised of the incoming number and alerted to the fact that accepting the call will cause the current call active over the data network, to be placed on hold. Finally, FIG. 9D depicts the appearance of the UI display window 904 following rejection of the incoming invitation shown as being received in FIG. 9C.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

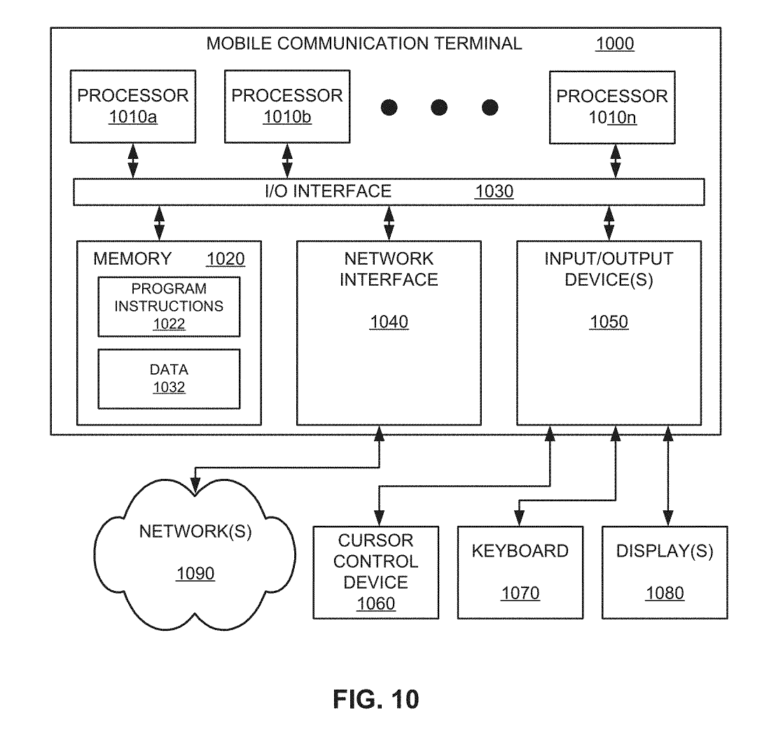

FIG. 10 depicts a system 1000 that can be utilized in various embodiments of an enhanced communication endpoint consistent with the present disclosure. In various embodiments, system 1000 may be configured to implement methods of FIGS. 4-7 as described above. The system 1000 may be used to implement any other system, device, element, functionality or method of the above-described embodiments. In the illustrated embodiments, system 1000 may be configured to implement methods 400, 500, 600 and 700 as processor-executable executable program instructions 1022 (e.g., program instructions executable by processor(s) 1010a-1010n) in various embodiments.

In the illustrated embodiment, system 1000 includes one or more processors 1010a-1010n coupled to a system memory 1020 via an input/output (I/O) interface 1030. System 1000 further includes a network interface 1040 coupled to I/O interface 1030, and one or more input/output devices 1050, such as cursor control device 1060, keyboard 1070, and display(s) 1080. In various embodiments, any of the components may be utilized by the system to receive user input described above. In various embodiments, a user interface may be generated and displayed on display 1080. In some cases, it is contemplated that embodiments may be implemented using a single instance of system 1000, while in other embodiments multiple such systems, or multiple nodes making up computer system 1000, may be configured to host different portions or instances of various embodiments. For example, in one embodiment some elements may be implemented via one or more nodes of system 1000 that are distinct from those nodes implementing other elements. In another example, multiple nodes may implement system 1000 in a distributed manner.

In different embodiments, computer system 1000 may be any of various types of devices, including, but not limited to, a personal computer system, a desktop computer, a laptop, a notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments processors 1010 may be general-purpose or embedded processors implementing any of a variety of instruction set architectures (ISAs). In multiprocessor systems, each of processors 1010 may commonly, but not necessarily, implement the same ISA.

System memory 1020 may be configured to store program instructions 1022 and/or data 1032 accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 1020. In other embodiments, program instructions and/or data may be received, sent or stored upon different types of computer-accessible media or on similar media separate from system memory 1020 or system 1000.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, some or all of the functionality of I/O interface 1030, such as an interface to system memory 1020, may be incorporated directly into processor 1010.

Network interface 1040 may be configured to allow data to be exchanged between system 1000 and other devices attached to a network (e.g., network 1090), such as one or more external systems or between nodes of system 1000. In various embodiments, network 1090 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, microphones, speakers, or any other devices suitable for entering or accessing data by one or more systems 1000. Multiple input/output devices 1050 may be present in system 1000 or may be distributed on various nodes of system 1000. In some embodiments, similar input/output devices may be separate from system 1000 and may interact with one or more nodes of system 1000 through a wired or wireless connection, such as over network interface 1040.

Those skilled in the art will appreciate that system 1000 is merely illustrative and is not intended to limit the scope of embodiments. In particular, the system and devices may include any combination of hardware or software that can perform the indicated functions of various embodiments, including computers, network devices, Internet appliances, PDAs, wireless phones, pagers, and the like. System 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from system 1000 may be transmitted to system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for operating a first mobile communication endpoint having a processor, memory and a transceiver for establishing communication sessions with other communication endpoints, comprising:
communicating with a second communication endpoint in a first communication session between the first mobile communication endpoint and the second communication endpoint over a first communication network, wherein the communicating comprises executing a first communication application at the first mobile communication endpoint;
receiving, at the first mobile communication endpoint, an invitation to establish a second communication session with a third communication endpoint over a communication network, wherein the first mobile communication endpoint is provisioned to handle the second communication session by executing a second communication application at the first mobile communication endpoint; and
processing the received invitation according to a specified call treatment option without interruption of the first communication session.

2. The method of claim 1, wherein the first communication network is a data network, and wherein the communicating comprises exchanging voice over internet protocol (VoIP) data packets between the first mobile communication endpoint and an internet telephony server.

3. The method of claim 1, wherein the invitation received during the receiving is an invitation to establish a second communication over a second communication network that is different from the first communication network, and wherein the second communication network is one of a data network or a voice communication network.

4. The method of claim 3, wherein the second communication network is a mobile telephony service network, and wherein the acceptance of the invitation comprises exchanging RF signals between a transceiver of the first mobile communication endpoint and a base station of mobile telephony service network.

5. The method of claim 1, further comprising monitoring, at the first mobile communication endpoint, a status of the first communication session.

6. The method of claim 1, wherein processing the received invitation includes:
initiating, on a display screen of the mobile communication terminal, display of a prompt for a user of the mobile communication endpoint to select the specified call treatment option.

7. The method of claim 6, wherein processing the received invitation further includes:
determining that the user of the mobile communication endpoint has selected an option of rejecting the invitation.

8. The method of claim 7, wherein processing the received invitation further includes:
instructing a native call handling application, stored in memory and executable by the processor of the mobile communication endpoint, to initiate re-direction of the invitation to a messaging server.

9. The method of claim 8, further including:
determining that the communication session between the first mobile communication endpoint and the second communication endpoint is no longer active; and
processing a subsequent invitation received by the first mobile communication endpoint according to a default call treatment option different from the specified call treatment option.

10. The method of claim 1, further including:
determining that the communication session between the first mobile communication endpoint and the second communication endpoint is no longer active; and
processing a subsequent invitation received by the first mobile communication endpoint according to a default call treatment option different from the specified call treatment option.

11. A mobile communication endpoint, comprising:
at least one processor;
a display;
at least one transceiver operative to exchange signals, over a first communication network, with a second communication endpoint in a first communication session, based on execution of instructions of a first communication application by the at least one processor; and
a memory containing instructions, executable by the at least one processor, to
receive, at the first mobile communication endpoint, an invitation to establish a second communication session with a third communication endpoint over a communication network, wherein the first mobile communication endpoint is provisioned to handle the second communication session by executing a second communication application at the first mobile communication endpoint; and
process the received invitation according to a specified call treatment option without interruption of the first communication session.

12. The mobile communication endpoint of claim 11, wherein the first communication network is a data network, and wherein the instructions in memory include instructions for exchanging voice over internet protocol (VoIP) data packets between the first mobile communication endpoint and an internet telephony server.

13. The mobile communication of claim 11, wherein the instructions in memory are executable by the processor for receiving, over a second communication network that is different from the first communication network, the invitation to establish a second communication, wherein the second communication network is one of a data network or a voice communication network, and wherein the instructions in memory include instructions for initiating an exchange of messages between the endpoint and the data network or voice communication network.

14. The mobile communication endpoint of claim 13, wherein the second communication network is a mobile telephony service network, and wherein the instructions in memory include instructions for initiating an exchanging of RF signals between the transceiver and a base station of mobile telephony service network.

15. The mobile communication endpoint of claim 11, wherein the memory further contains instructions for monitoring, at the first mobile communication endpoint, a status of the first communication session.

16. The mobile communication endpoint of claim 11, wherein instructions in memory for processing the received invitation comprise instructions for initiating display, on a display screen of the mobile communication terminal, display of a prompt for a user of the mobile communication endpoint to select the specified call treatment option.

17. The mobile communication endpoint of claim 16, wherein instructions in memory for processing the received invitation further comprise instructions for determining that the user of the mobile communication endpoint has selected an option of rejecting the invitation.

18. The mobile communication endpoint of claim 17, wherein instructions in memory for processing the received invitation further comprise instructions for initiating, by a native call handling application stored in memory and executable by the processor of the mobile communication endpoint, re-direction of the invitation to a messaging server.

19. The mobile communication endpoint of claim 18, wherein instructions in memory executable by the processor further include p1 instructions for determining that the communication session between the first mobile communication endpoint and the second communication endpoint is no longer active; and
instructions for processing a subsequent invitation received by the first mobile communication endpoint according to a default call treatment option different from the specified call treatment option.

20. The mobile communication endpoint of claim 11, wherein instructions in memory executable by the processor further include
instructions for determining that the communication session between the first mobile communication endpoint and the second communication endpoint is no longer active; and
instructions for processing a subsequent invitation received by the first mobile communication endpoint according to a default call treatment option different from the specified call treatment option.

21. A non-transitory computer readable medium containing instructions, executable by the processor of a first mobile communication endpoint having a display and a transceiver, for:
communicating with a second communication endpoint in a first communication session between the first mobile communication endpoint and the second communication endpoint over a first communication network, wherein the communicating comprises executing a first communication application at the first mobile communication endpoint;
receiving, at the first mobile communication endpoint, an invitation to establish a second communication session with a third communication endpoint over a communication network that is different from the first communication network, wherein the first mobile communication endpoint is provisioned to handle the second communication session by executing a second communication application at the first mobile communication endpoint; and
processing the received invitation according to a specified call treatment option without interruption of the first communication session.

22. The non-transitory computer readable medium of claim 21, further including instructions for causing a native call handling application, stored in memory and executable by the processor of the first mobile communication endpoint, to initiate re-direction of the invitation to a messaging server.

23. The non-transitory computer readable medium of claim 22, further including instructions for
determining that the communication session between the mobile communication endpoint and the second communication endpoint is no longer active; and
processing a subsequent invitation received by the mobile communication endpoint according to a default call treatment option different from the specified call treatment option.

24. The non-transitory computer readable medium of claim 21, further including instructions for
determining that the communication session between the mobile communication endpoint and the second communication endpoint is no longer active; and
processing a subsequent invitation received by the mobile communication endpoint according to a default call treatment option different from the specified call treatment option.
